(19) United States
(12) Patent Application Publication
(10) Pub. No.: US 2025/0365199 A1
(43) Pub. Date: Nov. 27, 2025

(54) ANOMALY DETECTION FOR DEVICE APPLICATION MAINTENANCE

(71) Applicant: Orange, Issy-les-Moulineaux (FR)

(72) Inventors: Naji Najari, Chatillon (FR); Samuel Berlemont, Chatillon (FR); Gregoire Lefebvre, Chatillon (FR)

(21) Appl. No.: 18/874,558

(22) PCT Filed: May 25, 2023
(86) PCT No.: PCT/EP2023/064054

§ 371 Date: Dec. 12, 2024

(30) Foreign Application Priority Data
Jun. 17, 2022 (FR) FR2205936

(51) Int. Cl. H04L 41/0866; H04L 41/0859; H04L 41/16

(52) U.S. Cl. CPC H04L 41/0866; H04L 41/0859; H04L 41/16

(57) ABSTRACT

A method for monitoring a device in a communication network is described. The method includes obtaining an observation sequence from observations of a network stream involving the device, and implementing a given artificial intelligence model associated with a firmware version of a reference device, the given model being trained to produce a reconstructed sequence from the observation sequence and a previous observation sequence and to determine a reconstruction error between the reconstructed sequence and the observation sequence, an error lower than a threshold indicating that the device is operating in the network with said firmware version. The reconstructed sequence is produced as a function of intra-sequence relationships between elements of the observation sequence and inter-sequence relationships between the observation sequence and the previous observation sequence.

### TECHNICAL FIELD

The present disclosure relates to the field of management services for communicating devices, also called connected devices or connected objects.

More particularly, the present disclosure relates to a method for managing a communicating device in a local area communication network and to a corresponding system, device, computer program and recording medium.

The present disclosure may be applied for example in digital services for the remote management of communicating devices by an operator and/or by a digital service provider.

Generally, such digital services are based essentially on two types of entities.

A management server, located in the network of the operator or of the digital service provider, is responsible for remotely carrying out maintenance, configuration and/or diagnostic operations on communicating devices present in local area networks.

Management clients, present on the managed communicating devices, ensure secure communication with the management server.

### PRIOR ART

Operating anomalies may occur in a local area network. However, in the context of local area networks comprising heterogeneous communicating devices that are not integrated into any digital remote management service or managed by different digital remote management services, it is not possible for the operator to determine which communicating device might be at the origin of operating anomalies.

Indeed, the operator is able to perform only diagnostics limited to the communicating devices that it manages in order to determine the origin of a malfunction. This is sufficient when the communicating devices provided by the operator are actually responsible for the malfunction. However, there may be local dependencies between communicating devices. For example, there may be dependencies in terms of connectivity when a communicating device provided by the operator connects to a third-party Wi-Fi repeater.

In order to safeguard the end user from an experience degraded by the occurrence of operating anomalies, the operator relies on their own digital remote management service in order to keep the communicating devices linked to this digital service up to date. These firmware updates generally correct the latest malfunctions reported by the end users. The operator runs more or less frequent update campaigns depending on the criticality of the firmware change.

A communicating device on the local area network might be at the origin of the operating anomaly. Indeed, it is not possible for the digital remote management service to simultaneously trigger the updating of the firmware of all of the communicating devices managed by the digital service. The end user may therefore still encounter a problem with a particular communicating device even though the latter forms part of the update campaign. In this case, a local management interface is generally made available to the end user so that they are able to trigger this operation manually and immediately.

It is in the common interest of the operator and its end users for the updates to be regular for all of the communicating devices of the end users, and not only for the communicating devices linked directly to the digital remote management service provided by the operator. The operator therefore seeks, proactively, to prompt the end user to manually bring about the installation of the latest versions available for each family of communicating devices.

However, the operator is not able to know the version of each communicating device connected to a local area network of an end user as soon as some of these communicating devices are managed by third-party providers that do not make such information accessible to the operator.

Attempting to infer the firmware version of a communicating device on the basis of studying the network traffic of the communicating device while it is operating is difficult to achieve.

Anomalies in network flows may be of three types: one-off, collective or contextual. To illustrate these types of anomalies, reference is made to FIG. 1, which shows various network flows in the form of four smoothed univariate signals:
a first reference, or nominal, network flow (3),
a second network flow (4) comprising a one-off anomaly,
a third network flow (5) comprising a contextual anomaly, and
a fourth network flow (6) comprising a collective anomaly.

When one datum of a time series is far, in the sense of Euclidean distance, from the other data in the series, it is considered to be a one-off anomaly. If a subset of data differs from the other data in the series, this characterizes a collective anomaly. The contextual anomaly is most difficult to detect since it occurs when a datum is deemed to be abnormal in a specific context.

In the context of application maintenance operations, it may be desirable for a digital remote management service, provided for example by an operator, to be able to detect the versions of a family of communicating devices at the local area network of an end user.

The following reference describes one known method for detecting anomalies in time series:
Z. Chen, D. Chen, X. Zhang, Z. Yuan and X. Cheng, Learning Graph Structures with Transformer for Multivariate Time Series Anomaly Detection in IoT, IEEE Internet of Things Journal, 2021.

In this reference, the authors propose to detect temporal anomalies using transformer (or self-attention model) neural networks. In particular, this approach assigns an anomaly score to each network flow and observations having a score greater than a predefined threshold are considered to be abnormal.

However, this method has limits that make it not particularly applicable to inferring the firmware version of a communicating device in real time.

In particular, this method is not robust to anomalies that may contaminate the learning base. Indeed, the authors assume that all learning data are nominal. In practice, anomalies may infiltrate the data collected for learning. In this case, the performance of this approach may be impacted significantly.

There is a need for a method that makes it possible to rectify insufficiencies and/or drawbacks of the prior art and/or to make improvements thereto, and that in particular allows robust detection of contextual anomalies in time series of network flow metadata of communicating devices.

### SUMMARY

The present disclosure aims to improve the situation.

What is proposed is a method for monitoring at least one device in a communication network, the method comprising:
obtaining an observation sequence based on observations of a network flow involving the device,
implementing at least one given artificial intelligence model associated with a firmware version of at least one reference device, the given model being trained to produce a reconstructed sequence based on the observation sequence and on a preceding observation sequence and to determine a reconstruction error between the reconstructed sequence and the observation sequence, a reconstruction error lower than a threshold characterizing the fact that the device is operating in the network with said firmware version,
the reconstructed sequence being produced on the basis of intra-sequence relationships between elements of the observation sequence and of inter-sequence relationships between the observation sequence and the preceding observation sequence.

The proposed monitoring method allows robust detection of anomalies, including contextual anomalies, in observations of a network flow involving one or more devices. The network flow is understood to mean a set of digital data transiting on the communication network. It may for example involve digital data packets transmitted over time by various source devices to various destination devices. The observations of the network flow are digital data relating to the network flow. It may for example involve metadata extracted from headers of these packets. The observations of the network flow may for example be collected continuously, so as to form a time series that is able to be divided into observation sequences. Thus, the observation sequences are defined as being digital data relating to the network flow, collected during an observation window. The robustness of the anomaly detection is provided by the use of the mentioned intra-sequence and inter-sequence relationships as a basis for reconstructing an observation sequence.

The proposed method makes it possible to detect anomalies in real time based on the network flow. Indeed, the computing time required to implement the method is compatible with this continuous implementation. Moreover, it does not require complex parameterization of algorithms or supervised learning. Finally, it is robust to noisy data and to aberrant values during training.

The proposed monitoring method is applicable in particular in the field of remote assistance, in which it offers the possibility of determining whether or not any one or more devices are operating in a communication network with the same given firmware version as one or more reference devices.

What is proposed is a method for managing at least one communicating device in a communication network, the method comprising:
monitoring the communicating device in accordance with the above monitoring method, and
issuing a management instruction for the communicating device on the basis of a comparison between the reconstruction error determined when implementing the given model and the threshold.

The proposed management method, which encompasses the abovementioned monitoring method and has the same advantages, is applicable in the field of maintenance in that it facilitates automatic maintenance operations. It makes it possible for example to detect devices whose network traffic exhibits abnormal characteristics in order to trigger advanced diagnostics, identify the origin of the problem, and enable automatic repair before any request for assistance from end users.

What is also proposed is a computer program comprising instructions for implementing one of the above methods when this program is executed by a processor.

What is also proposed is a non-transient computer-readable recording medium on which there is recorded a program for implementing one of the above methods when this program is executed by a processor.

What is also proposed is a data processing circuit comprising a processor connected to the above non-transient recording medium.

What is also proposed is a system comprising a plurality of communicating devices in a communication network, at least one of the communicating devices comprising the above data processing circuit.

The above monitoring method may optionally comprise certain additional functions as defined below.

In some examples, implementing at least one given model comprises implementing a plurality of models respectively associated with a respective firmware version of the at least one reference device, each said model being respectively trained to produce a respective reconstructed sequence based on the observation sequence and on the preceding observation sequence and to determine a respective reconstruction error between the respective reconstructed sequence and the observation sequence, the reconstruction error determined when implementing the given model having the lowest value from among the respective reconstruction errors.

By implementing such a plurality of models, it is possible to determine the exact firmware version of a monitored device operating in the network, by identifying it from among a set of predefined possible versions that are each respectively associated with a respective model.

Indeed, when the monitored device and the at least one reference device belong to one and the same family of devices, and when furthermore the reconstruction error determined when implementing a model is lower than the mentioned threshold, then the firmware version with which the monitored device is operating in the network is identified precisely as being that associated with this model.

A family of communicating devices is defined as being a group of communicating devices sharing the same firmware version. However, these communicating devices may be different, for example in terms of their operation or form factor.

In some examples, implementing at least one given model comprises implementing a set of models comprising a plurality of subsets respectively associated with a respective family of reference devices and each comprising at least one model associated with a firmware version of at least one reference device of the respective family, the given model belonging to one of the subsets, the reconstruction error, determined when implementing the given model (MODᵢⱼ), lower than the threshold furthermore characterizing the fact that the device belongs to the family associated with the subset comprising the given model.

By implementing such a set of models, it is possible to determine both the family of devices to which a monitored device belongs and the firmware version with which it is operating in the network.

When, conversely, the reconstruction errors determined when implementing each model are all greater than a threshold, then the network flow involving the monitored device may simply be considered to be unknown, or to exhibit an anomaly.

Such a scenario occurs for example when none of the subsets is associated with a family to which the monitored device belongs, or when none of the models is associated with the firmware version with which the monitored device is operating in the network, or else when this firmware version is corrupted.

The above management method may optionally comprise certain additional functions as defined below.

In some examples, when the determined reconstruction error is lower than the threshold and the firmware version associated with the given model is obsolete, the management instruction comprises a recommendation to update the firmware version with which the device is operating in the network.

A notification and recommendation service may thus propose targeted firmware updates for one or more monitored and managed devices whose firmware version is identified as no longer being up to date.

In some examples, the method furthermore comprises, when the determined reconstruction error is greater than the threshold, detecting an anomaly, and the management instruction is issued on the basis of the anomaly.

A notification and recommendation service may thus for example propose general firmware updates for all of the devices present only on the prior condition that the firmware version of one or more monitored devices was not able to be identified.

### BRIEF DESCRIPTION OF THE DRAWINGS

Other features, details and advantages will become apparent from reading the following detailed description, and from analyzing the appended drawings, in which:

FIG. 1 illustrates various types of anomalies in time series for a univariate signal.

FIG. 2 illustrates a system comprising a plurality of communicating devices in a local area communication network in one exemplary embodiment.

FIG. 3 illustrates a system comprising a plurality of communicating devices in a local area communication network in one variant embodiment.

FIG. 4 illustrates a general algorithm of a computer program for implementing, when this program is executed by a processor, a method for training at least one artificial intelligence model in one exemplary embodiment.

FIG. 5 illustrates a general algorithm of a computer program for implementing, when this program is executed by a processor, an artificial intelligence model in one exemplary embodiment.

FIG. 6 illustrates a general algorithm of a computer program for implementing, when this program is executed by a processor, a method for managing at least one communicating object in one exemplary embodiment.

FIG. 7 illustrates a data processing circuit in one exemplary embodiment.

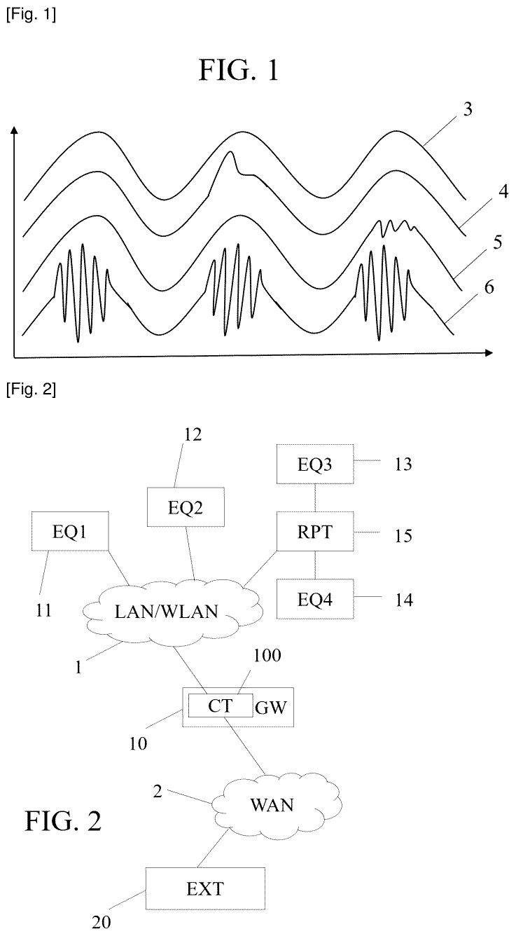

### DESCRIPTION OF THE EMBODIMENTS

The proposed technique makes it possible to rectify drawbacks of the prior art and proposes to monitor communicating objects in a communication network. This monitoring offers robust detection of anomalies, including contextual anomalies, in time series of network flow metadata of communicating devices. The detected anomalies make it possible in particular to trigger requests to update the version of the firmware of communicating devices in their latest functional version.

The general principle of the proposed technique is based on comparing a behavior of a communicating device with various possible identified behaviors. Each of these possible behaviors is modeled independently and is associated with a possible firmware version for a reference device or for a family of reference devices. To this end, for a plurality of reference devices, metadata are extracted from network traffic during a time interval subdivided into sub-intervals, forming the same number of observation windows. These metadata may comprise for example source IP addresses, destination IP addresses, sizes of incoming and outgoing packets, timestamps, etc. The metadata extracted from the network traffic during an observation window form an observation sequence.

The observation sequences serve as a basis for modeling the behavior of each reference device, such that a list of models, denoted MODᵢⱼ, is generated. In this notation, the index j denotes a family of reference devices from among a set of families under consideration, and the index i denotes a firmware version from among a set of possible versions for the family i under consideration. In other words, each model MODᵢⱼ is the fruit of automatic training aimed at compressing and then reconstructing the observation sequences continuously for a family of communicating devices.

A reconstruction error is determined based on the observation sequence and on the sequence reconstructed by the model MODᵢⱼ. When this reconstruction error is lower than a threshold, it is possible to infer that the observation sequence corresponds to network traffic involving a device from the family i operating under the firmware version j.

When none of the models MODᵢⱼ in the list of generated models manages to correctly reconstruct an observation sequence, that is to say when the reconstruction errors determined for each of the reconstructed sequences are all greater than a threshold, this means that the network traffic for this device exhibits unknown characteristics. These unknown characteristics may be grouped together under the generic term “anomaly”. An anomaly occurs for example when the device does not belong to any of the predefined families. An anomaly may also occur when the device, although it belongs to one of the predefined families, is not operating under any of the predefined firmware versions, or is operating under a corrupted firmware version.

In the remainder of the description, one exemplary implementation of the proposed technique will be described in detail with reference to FIGS. 2 to 7. The particular case in which the communication network is a local area communication network will also be adopted.

FIG. 2 illustrates a system comprising a plurality of communicating devices (10, 11, 12, 13, 14, 15) in a LAN/WLAN local area communication network (1). One of the communicating devices is a network access gateway GW (10), also called network gateway, interfacing the local area communication network (1) with a WAN wide area communication network (2) and allowing the communicating devices to access the wide area network. The communicating devices may comprise various types of devices EQ1, EQ2, EQ3, EQ4 (11, 12, 13, 14) able to be used by a user, such as a computer, a mobile telephone, a touchscreen tablet, a communicating speaker, a games console, a communicating device in the field of lighting, health, safety, heating, air quality, etc. Moreover, the communicating devices may comprise one or more network devices other than the access gateway, such as a switch, a hub, a router, a repeater RPT (15), etc.

In FIG. 2, the topology of the local area network (1) is shown as a tree. Some communicating devices EQ1 (11), EQ2 (12) communicate directly with the network gateway (10), while other user devices EQ3 (13), EQ4 (14) for their part communicate with a repeater RPT (15) the main role of which is to extend the coverage of the network gateway (10). However, the proposed technique is not limited to any particular topology of the local area network (1) and is applicable to any installation, for example a home installation or else within a business, regardless of the network devices present and also regardless of the number and nature of the communicating devices.

A device EXT (20), external to the local area network (1), is also shown in FIG. 2 and denotes a device able to communicate with one or more entities of the local area network, for example the network gateway GW (10). Depending in particular on the topology of the local area network, this communication takes place either directly via the wide area network (2) or indirectly via both the wide area network (2) and the local area network (1).

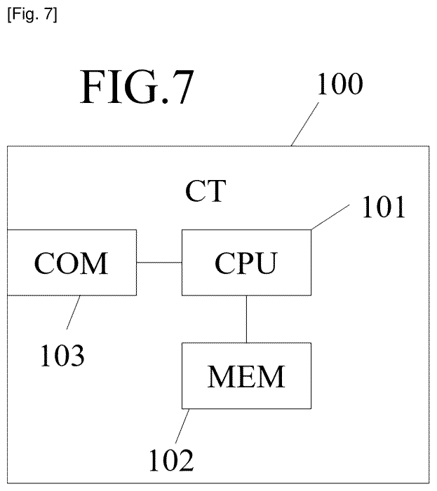

At least any one of the devices shown comprises a processing circuit CT (100) configured to implement the proposed technique. In the example of FIG. 2, such a processing circuit CT (100) is integrated into the network access gateway GW (10), thereby allowing the processing circuit CT (100) to have direct access to all traffic transiting through the local area network. FIG. 7 specifically describes the structure of such a processing circuit (100). Said processing circuit comprises at least one processor CPU (101) connected to at least one non-transient memory MEM (102) and to a communication interface COM (103) for communicating with the local area network (1). The non-transient memory (102) stores one or more instructions of a computer program for implementing a method for managing the system of FIG. 2 when this program is executed by a processor. The operation of the program may also require the presence of a transient memory within the processing circuit. In functional terms, during the execution of the program, such a processing circuit (100) or such a set of processing circuits may be seen as a group of functional modules, or logic modules, respectively dedicated to specific tasks.

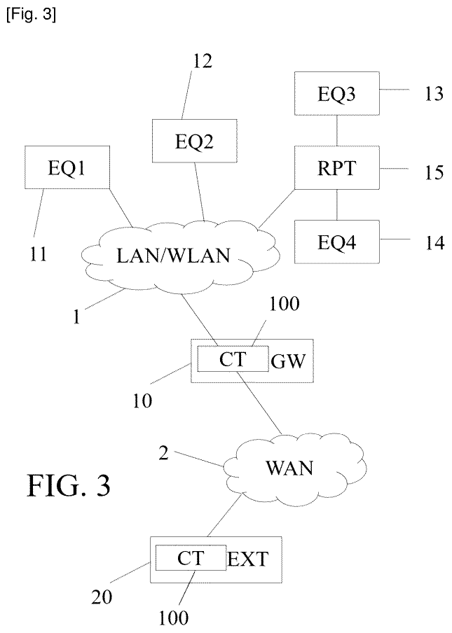

In one variant illustrated in FIG. 3, multiple processing circuits CT (100) may be configured collectively to implement the proposed method. Such processing circuits CT (100), each comprising a structure corresponding to that of FIG. 7, may be integrated into various devices such as the network access gateway GW (10) and the device EXT (20). A first processing circuit CT (100) at the network gateway (10) may thus for example be configured to implement a management client and a second processing circuit CT (100) at the external device (20) may be configured to implement a management server dialoging with the management client, the steps of the proposed technique then being distributed between the management server and the management client.

A description will now be given, in one particular exemplary embodiment, of a method for managing communicating equipment. This method is based on artificial intelligence models.

Each of these models, denoted MODᵢⱼ, is associated with a family i of reference devices and with a firmware version j of the reference devices of the family i. The index i is between 1 and I, where I denotes the number of families of reference devices taken into account by the training method, and the index j is between 1 and Jₗ, where Jₗ denotes the number of firmware versions supported for the family i, this number being variable from one supported family to another. The model training method may be implemented by any processing circuit (100) in any system comprising one or more reference devices in a communication network, such as for example the systems of FIGS. 2 and 3.

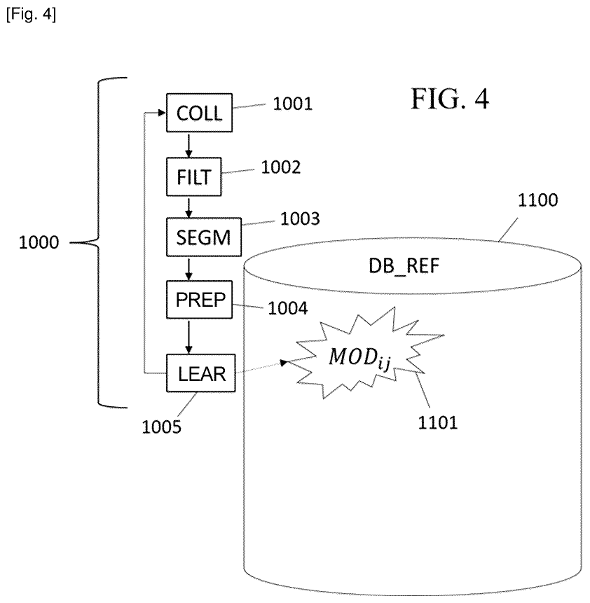

A description will now be given, with reference to FIG. 4, of one example of a method (1000) for training, or learning, an artificial intelligence model MODᵢⱼ (1101) designed to implement the management method.

A data collector (1001) records, during a reference period (for example a period of 7 days), metadata of network traffic involving at least one or more reference devices of the family i operating in the network with the firmware version j.

For example, in the system of FIG. 2 or 3, these metadata may be collected from a probe provided on a device, such as the network gateway (10), through which the entire network flow involving the one or more reference devices of the family i operating in the network with the firmware version j transits. When the reference period is long enough with regard to the family i under consideration, the metadata thus collected are liable to reflect all nominal operating situations of these one or more reference devices.

Otherwise, when the metadata are collected at a device via which only part of the network flow involving the one or more reference devices of the family i operating in the network with the firmware version j transits, the metadata thus collected may, all the same, reflect some of the nominal operating situations of these one or more reference devices. Such a case is possible for example in the context of a mesh network in which the network traffic does not always follow the same route.

At the output of the data collector, a data filter (1002) makes it possible to sort the recorded metadata by selecting those considered to be useful for training the model MODᵢⱼ (for example MAC (Medium Access Control) addresses, IP (Internet Protocol) addresses, packet sizes, source addresses, destination addresses, etc.). This selection may be supervised or unsupervised. For example, the filter may be configured to select, specifically, metadata relating to a family i in version j, that is to say metadata corresponding for example to a source address and/or to a destination address contained in a list of listed addresses, associated with a reference device of the family i operating in the network with the firmware version j. In general, the implementation of such a selection is a procedure that is well known to those skilled in the art and that is not expanded on any further here.

At the output of the data filter, a segmentor (1003) makes it possible, based on the set of selected metadata, to form groups of metadata to be analyzed jointly. The size of these groups of metadata may be fixed beforehand, a group defining an analysis window. In one exemplary implementation, the recorded metadata are segmented into groups of 100 samples without overlap.

At the output of the segmentor, one or more preprocessing modules (1004) make it possible to carry out preprocessing operations on the formed groups of metadata. Various examples of preprocessing operations that may be performed by these preprocessing modules will now be mentioned non-exhaustively. One-hot encoding, or 1-of-n encoding, consists in encoding an n-state variable on n bits. Such encoding is common in machine learning to represent a category variable as digital data. Frequency encoding, or count encoding, makes it possible to reflect the frequency of occurrence of categories. The aim of normalization is to standardize the data by redimensioning them so that they are comparable on a common scale. Resampling makes it possible, on the basis of samples forming a group of metadata, to draw new hypothetical samples that reflect the same distribution characteristics.

At the end of the one or more preprocessing operations, sequences of data, or observation sequences, denoted Sᵢⱼ₍ₖ₎ and indexed by k=1 . . . n in order of occurrence, are obtained. In one exemplary implementation, n may be set to be equal to 100. The observation sequences thus obtained are the learning sequences for the artificial intelligence model MODᵢⱼ.

A learning module (1005) is provided to train the model MODᵢⱼ. The model MODᵢⱼ is trained by successively providing the observation sequences at the input of the learning module, which attempts to reconstruct them.

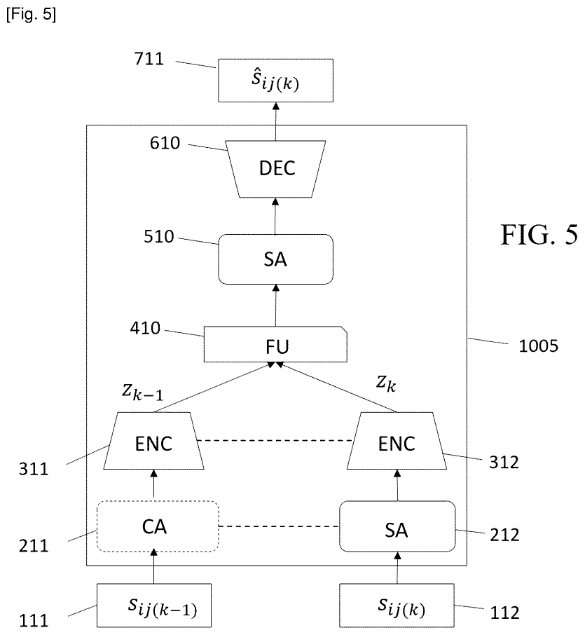

The detailed operation of the learning module (1005) will now be described with reference to FIG. 5, in one exemplary embodiment.

Two consecutive observation sequences Sᵢⱼ₍ₖ₎ (111) and Sᵢⱼ₍ₖ₋₁₎ (112) are provided at the input of the learning module (1005). The current observation sequence Sᵢⱼ₍ₖ₎ is the sequence to be reconstructed. The preceding observation sequence Sᵢⱼ₍ₖ₋₁₎ represents an element of a history of observation sequences.

Two branches of operations are carried out in parallel.

In a first branch of operations, the current observation sequence Sᵢⱼ₍ₖ₎ is processed by a first module formed of a self-attention module (212) and of an encoder (312). Self-attention is a learning mechanism for artificial intelligence models that is known to those skilled in the art and that is described in particular in A. Vaswani, N. Shazeer, N. Parmar, J. Uszkoreit, L. Jones, A. Gomez, Ł. Kaiser, and I. Polosukhin, Advances in Neural Information Processing Systems, page 5998--6008. (2017). By applying a self-attention mechanism to the current observation sequence, the self-attention module provides, at output, intra-sequence relationships denoted Zₖ, that is to say relationships within the current observation sequence Sᵢⱼ₍ₖ₎. The encoder (312) is configured to encode these intra-sequence relationships.

In a second branch of operations, the current observation sequence and at least the preceding observation sequence Sᵢⱼ₍ₖ₋₁₎ are processed by a second module formed of a co-attention module (211) and of an encoder (311). Co-attention is a learning mechanism for artificial intelligence models that is known to those skilled in the art and that is described in particular in Haoran Zhang and Diane Litman, 2018, Co-Attention Based Neural Network for Source-Dependent Essay Scoring, Proceedings of the Thirteenth Workshop on Innovative Use of NLP for Building Educational Applications, pages 399-409, New Orleans, Louisiana, Association for Computational Linguistics. By applying a co-attention mechanism to the current observation sequence, the co-attention module provides, at output, inter-sequence relationships, that is to say relationships between the current observation sequence Sᵢⱼ₍ₖ₎ and a history of observation sequences. In one exemplary implementation, the history of observation sequences is represented by the single preceding observation sequence Sᵢⱼ₍ₖ₋₁₎ and the inter-sequence relationships are denoted Zₖ₋₁. In other exemplary implementations, the history of observation sequences may be represented by p preceding observation sequences (Sᵢⱼ₍ₖ₋₁₎, Sᵢⱼ₍ₖ₋₂₎, . . . , Sᵢⱼ₍ₖ₋ₚ₎) and the inter-sequence relationships are denoted Zₖ₋ₚ. The encoder (311) is configured to encode these intra-sequence relationships.

Although the first and the second module are able to be implemented in the form of completely separate and distinct modules, in one particular embodiment, these modules are implemented in the form of a Siamese neural network. This particular embodiment makes it possible to obtain better robustness to detecting anomalies, in particular contextual anomalies. As an alternative, it is also possible to construct a learning module having an architecture that is functionally similar to that of a Siamese neural network.

In one exemplary implementation, the first and the second module are implemented in the form of a transformer Siamese neural network, self-attention is defined by:

SA=attention (q=k, u=eₜ) (1)

and co-attention is defined by:

CA=attention (q=eₜ, k, u=eₜ₋₁) (2).

The quantities q, v and eₜ are usually defined, in the field of transformer neural networks, as denoting query, value, and the element of the observation sequence under consideration at the time t. Additional information, in particular regarding the quantities q, v and eₜ, and more generally regarding the implementation of attention mechanisms by way of transformer neural networks, is available in A. Vaswani, N. Shazeer, N. Parmar, J. Uszkoreit, L. Jones, A. Gomez, Ł. Kaiser, and I. Polosukhin. Advances in Neural Information Processing Systems, page 5998-6008, (2017).

In one exemplary implementation involving a fully connected neural network, the relationships encoded by the first and the second module are fused by a fuser (410), and then processed by a third module so as to produce, at output, a reconstructed sequence Ŝᵢⱼ₍ₖ₎ (711) that is a reconstruction of the input sequence Sᵢⱼ₍ₖ₎ (111). In functional terms, the third module comprises at least a decoder (610) configured to decode the encoded relationships. In one exemplary implementation, the third module furthermore comprises a transformation module (510) configured to transform the encoded relationships by way of a self-attention mechanism before they are decoded.

During the training phase, the encoding operations carried out by the first and the second module, along with the decoding carried out by the third module, are gradually refined each time a new observation sequence is processed, such that the reconstructed sequences are collectively as similar as possible to the learning sequences. The model MODᵢⱼ thus learns to correctly reconstruct the observation sequences originating from the family i of reference devices operating in a network with the firmware version j.

In one embodiment, the model MODᵢⱼ learns to reconstruct the learning sequences by minimizing the Geman-McClure robust function. This function is defined by:

$${e}_{kij} = 2 \frac{{( \frac{{d}_{{ij ( k )}_{)}}}{c} )}^{2}}{{( \frac{{c}_{ij ( k )}}{c} )}^{z} + 4} \qquad ( 3 )$$

$${d}_{ij ( k )} = {‖ {s}_{ij ( k )} - {\hat{s}}_{ij ( k )} ‖}^{2} , \qquad ( 4 )$$

$$c = λ \cdot IQR \qquad ( 5 )$$

The quantity eₖ is the result of computing a reconstruction error in the observation sequence Sᵢⱼ₍ₖ₎. This computation involves the Euclidean distance dᵢⱼ₍ₖ₎ between the observation sequence Sᵢⱼ₍ₖ₎ and the reconstructed sequence Ŝᵢⱼ₍ₖ₎, along with a parameter denoted c, which oversees the robustness of the function and is set as a multiple of the interquartile range (IQR) of all metadata of the family i in version j, with λ=0.1 for example.

Once the training of the model MODᵢⱼ (1101) is complete, said model may be stored in a reference base (1100), denoted DB_REF, and then a new iteration of the method of FIG. 4 may be triggered in order to train a new model MOD_{i,j+1} for another firmware version j+1 of the family i if such a version exists, or a new model MOD_{i+1,1} for another family i+1 of reference devices. This approach may be repeated until it covers as many families as desired and, for each family covered, as many firmware versions as desired.

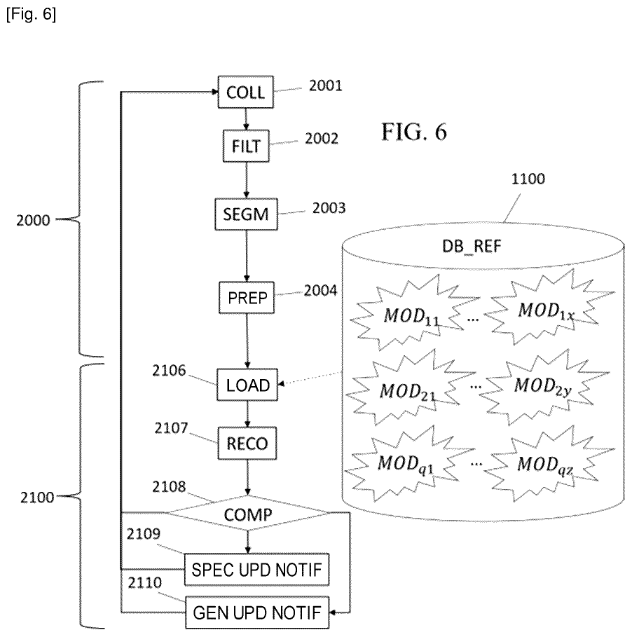

A description will now be given, with reference to FIG. 6, of a method for managing communicating devices. This management method comprises a metadata collection and preprocessing procedure (2000) carried out using a collector (2001), a filter (2002), a segmentor (2003) and one or more preprocessing modules (2004).

The entities (2001, 2002, 2003, 2004) provided for implementing the metadata collection and preprocessing procedure (2000) have numerous similarities with those (1001, 1002, 1003, 1004) provided for implementing the first steps of the training method (1000) described above in conjunction with FIG. 4, apart from two differences.

Specifically, in the proposed management method:
the collector (2001) continuously collects metadata relating to current network flows, liable to involve all types of communicating devices, operating under any firmware version, and
the filter (2002) organizes these collected metadata using a procedure modeled on that of the filter (1002), such that the observation sequences at the output of the one or more preprocessing modules (2004) have a format identical or similar to that of the observation sequences arising from observations of network flows involving the reference devices.

By way of a variant embodiment, the filter (2002) may extract a subset of metadata considered to be useful for collectively managing a group of communicating devices that are presumed to be linked, that is to say presumed to belong to one and the same family and presumed to be operating in the network with one and the same firmware version.

In the proposed management method, the operation of the segmentor (2003) and that of the one or more preprocessing modules (2004) are unchanged compared to those described in conjunction with FIG. 4.

The management method also comprises a procedure of processing data and of managing communicating devices (2100).

A loader (2106) loads a set of artificial intelligence models MODᵢⱼ that have been trained beforehand into memory. This may involve for example all of the models stored in the reference base DB_REF (1100) described above.

A sequence reconstructor (2107) is provided for implementing each artificial intelligence model MODᵢⱼ loaded beforehand by the loader.

In functional terms, the sequence reconstructor may be considered to comprise a plurality of instances in parallel, each instance being associated with a respective model MODᵢⱼ and operating in the same way as the learning module described in conjunction with FIG. 4 and in more detail in conjunction with FIG. 5.

It will now be considered, for the purposes of implementing any number of models MODᵢⱼ, that, at a current time, a current observation sequence Sᵢⱼ₍ₖ₎ and at least one preceding observation sequence Sᵢⱼ₍ₖ₋₁₎, relating to one and the same device, are obtained as sequences to be analyzed. The analysis of these observation sequences aims to characterize the family to which this communicating device belongs and/or the firmware version with which this communicating device is operating in the network.

Implementing each of the artificial intelligence models MODᵢⱼ involves:
providing the same current observation sequence to be analyzed Sᵢⱼ₍ₖ₎ to all of the first modules in order to determine the intra-sequence relationships,
providing the same current observation sequences to be analyzed Sᵢⱼ₍ₖ₎ and preceding observation sequence to be analyzed Sᵢⱼ₍ₖ₋₁₎ to all of the second modules in order to determine the inter-sequence relationships, and
obtaining, for each of the artificial intelligence models that are implemented, a respective reconstructed sequence Ŝᵢⱼ₍ₖ₎ that is a reconstruction, by a respective third module, of the current observation sequence to be analyzed Sᵢⱼ₍ₖ₎.

For each reconstructed sequence thus obtained, a reconstruction error, denoted eₖᵢⱼ, is computed, for example in accordance with equation (3). For a sequence Ŝᵢⱼ₍ₖ₎ reconstructed by implementing the model MODᵢⱼ, the result of the reconstruction error computation is thus for example a Euclidean distance between this reconstructed sequence Ŝᵢⱼ₍ₖ₎ and the current observation sequence Sᵢⱼ₍ₖ₎ from which it originates. This Euclidean distance is a positive quantity indicative of the quality of the reconstruction. The closer it is to zero, the better the quality of the reconstruction. The reconstruction errors for each reconstructed sequence may be compared with one another with a view to identifying the family of communicating devices to which the communicating device to be managed belongs and the firmware version with which it is operating in the network.

More precisely, comparing the reconstruction errors with one another makes it possible to determine the minimum error, denoted eₖ, that is to say the minimum error value obtained for all of the error computations carried out. From among all of the models MODᵢⱼ, the one the implementation of which produced, at output, the reconstructed sequence exhibiting the minimum error eₖ is a given model denoted MODᵢⱼ, and is the model representing the behavior, in the network, of the communicating devices belonging to the family î and operating with the firmware version j.

A comparator (2108) compares the minimum reconstruction error eₖ with a threshold Tₘᵢₙ the value of which, which is fixed, is specific to the given model MODᵢⱼ.

If the minimum reconstruction error eₖ is lower than the threshold Tₘᵢₙ, then the communicating device to which the observation sequence relates is identified as belonging to the family î and operating with the firmware version ĵ. If this version ĵ is final for the family î, then it may be concluded that the communicating device is already operating in the network with up-to-date firmware, and it is not necessary to trigger any update of this communicating device. If, conversely, the version ĵ is not final for the family î, a notification and recommendation service may issue a notification (2109) offering an update of the firmware of the communicating device of the family î.

If the minimum reconstruction error eₖ is greater than the threshold Tₘᵢₙ, then the communicating device to which the observation sequence relates is identified as unknown, that is to say belonging to an unknown family, or operating with an unknown firmware version, or else exhibiting anomalies. Optionally, when the communicating device to which the observation sequence relates is identified as unknown, provision may be made to store the observation sequence in memory, with a view to a subsequent analysis. A notification and recommendation service may furthermore for example issue a notification (2110) recommending an update of all of the firmware available for the communicating devices identified as unknown.

The notification service may be a service designed and customized so as to inform the relevant party (for example a client, an object manager, etc.) that it is necessary to update the firmware of one or more communicating devices, or of one or more families of communicating devices.

1. A method for monitoring a device in a communication network, the method comprising:
obtaining an observation sequence based on observations of a network flow involving the device,
implementing at least one given model associated with a firmware version of at least one reference device, the given model being suitable for:
producing a reconstructed sequence based on the observation sequence and on a preceding observation sequence, and
determining a reconstruction error between the reconstructed sequence and the observation sequence, a reconstruction error lower than a threshold indicating that the device is operating in the network with said firmware version.

2. The method of claim 1, wherein implementing the at least one given model comprises implementing a plurality of models respectively associated with a respective firmware version of the at least one reference device,
each said model being respectively suitable for producing a respective reconstructed sequence based on the observation sequence and on the preceding observation sequence and for determining a respective reconstruction error between the respective reconstructed sequence and the observation sequence,
the reconstruction error determined when implementing the given model having the lowest value from among the respective reconstruction errors.

3. The method of claim 1, wherein implementing the at least one given model comprises implementing a set of models comprising a plurality of subsets respectively associated with a respective family of reference devices and each comprising at least one model associated with a firmware version of at least one reference device of the respective family, the given model belonging to one of the subsets, the reconstruction error, determined when implementing the given model, being lower than the threshold further indicating that the device belongs to the family associated with the subset comprising the given model.

4. A method for managing a communicating device in a communication network, the method comprising:
monitoring the communicating device in accordance with the method of claim 1, and
issuing a management instruction for the communicating device on the basis of a comparison between the reconstruction error determined when implementing the given model and the threshold.

5. The method of claim 4, wherein, upon a determination that the determined reconstruction error is lower than the threshold and the firmware version associated with the given model is obsolete, the management instruction comprises a recommendation to update the firmware version with which the device is operating in the network.

6. The method of claim 4, further comprising, upon a determination that the determined reconstruction error is greater than the threshold, detecting an anomaly, wherein the management instruction is issued on the basis of the anomaly.

7. (canceled)

8. A non-transitory computer-readable recording medium having stored thereon instructions which, when executed by a processor, cause the processor to implement the method of claim 1.

9. A data processing device comprising:
the non-transitory computer-readable recording medium of claim 8; and
a processor connected to the non-transitory computer-readable recording medium.

10. A system comprising a plurality of communicating devices in a communication network, at least one of the communicating devices comprising the data processing device of claim 9.

11. The method of claim 1, wherein said at least one given model is an artificial intelligence model.

12. The method of claim 1, wherein the reconstructed sequence is produced on the basis of intra-sequence relationships between elements of the observation sequence and of inter-sequence relationships between the observation sequence and the preceding observation sequence.
